(19) United States
(12) Patent Application Publication
(10) Pub. No.: US 2024/0137334 A1
(43) Pub. Date: Apr. 25, 2024

(54) SYSTEM AND METHOD WITH REAL TIME MESSAGING

(71) Applicant: Visa International Service Association, San Francisco, CA (US)

(72) Inventors: Ivan Ponomarov, Krakow (PL); Keith Stephen Brindley, Wokingham (GB); Ranveer Raj Jain, Dubai (AE); Volodymyr Ivanovich Bilous, Sofia (BG); Hema Mestha, Dubai (AE); Oleksandr Nikolayevich Yablunivskyy, Kiev (UA); Koni Uttam Nayak, Dubai (AE); Harsha Sathyanarayana Naga, Dubai (AE)

(73) Assignee: Visa International Service Association, San Francisco, CA (US)

(21) Appl. No.: 18/489,673

(22) Filed: Oct. 17, 2023

Related U.S. Application Data
(60) Provisional application No. 63/418,400, filed on Oct. 21, 2022.

(51) Int. Cl. H04L 51/48; G06Q 20/38; G06Q 20/40; H04L 9/40; H04L 51/046

(52) U.S. Cl. CPC H04L 51/48; G06Q 20/3821; G06Q 20/4016; H04L 51/046; H04L 63/0428; G06F 9/546

(57) ABSTRACT

A method is disclosed. The method includes receiving, from a receiver institution computer, an interaction request message for an interaction with a sender identifier associated with a sender and interaction details. The method also includes transmitting a plurality of notifications comprising the sender identifier to a plurality of sender institution computers. The method also includes receiving a plurality of responses from the plurality of sender institution computers, one or more responses indicating that the sender identifier is stored at the sender institution computers, and then providing the interaction details and/or additional interaction details to one or more of the sender institution computers that store the sender identifier.

### CROSS-REFERENCES TO RELATED APPLICATIONS

This application is a non-provisional of and claims the benefit of priority of U.S. Provisional Application No. 63/418,400 filed on Oct. 21, 2022, which is herein incorporated by reference in its entirety for all purposes.

### BACKGROUND

In a typical real time interactions involving aliases, both a sender and a receiver of value need to enroll with an alias directory. The alias directory maps aliases to real credentials. If the alias directory receives an alias in an interaction request message, then it can return the corresponding credential. The credential can then be used to conduct the interaction.

Improvements can be made to conventional real time interactions involving aliases. For example, if an alias is not in the alias directory, then the request for interaction is declined. This can be inconvenient and frustrating for users, and can also cause them to restart the interaction requests through other means. This can also result in the use of additional computing resources. Additionally, registration of aliases can be cumbersome and also results in the use of additional computing resources.

Embodiments of the disclosure address this problem and other problems individually and collectively.

### SUMMARY

One embodiment of the invention includes a method. The method comprises receiving, by a real time messaging computer from a receiver institution computer, an interaction request message for an interaction comprising a sender identifier associated with a sender and interaction details; transmitting, by the real time messaging computer, a plurality of notifications comprising the sender identifier to a plurality of sender institution computers; receiving, by the real time messaging computer, a plurality of responses from the plurality of sender institution computers, one or more responses indicating that the sender identifier is stored at the sender institution computers; and providing, by the real time messaging computer, the interaction details and/or additional interaction details to one or more of the sender institution computers that store the sender identifier.

Another embodiment of the invention includes a real time messaging computer. The real time messaging computer may comprise a non-transitory computer readable medium comprising code, executable by a processor, to perform operations comprising: receiving, from a receiver institution computer, an interaction request message for an interaction comprising a sender identifier associated with a sender and interaction details; transmitting a plurality of notifications comprising the sender identifier to a plurality of sender institution computers; receiving a plurality of responses from the plurality of sender institution computers, one or more responses indicating that the sender identifier is stored at the sender institution computers; and providing the interaction details and/or additional interaction details to one or more of the sender institution computers that store the sender identifier.

Another embodiment of the invention includes a method comprising: receiving, by a receiver institution computer, an interaction request message associated with an interaction, the interaction request message comprising a sender identifier associated with a sender and interaction details comprising a value from a receiver device; transmitting, by the receiver institution computer, the interaction request message to a real time messaging computer, wherein the real time messaging computer transmits a plurality of notifications comprising the sender identifier to a plurality of sender institution computers, and receives a plurality of responses from the plurality of sender institution computers, indicating that the sender identifier is stored at the sender institution computers; and receiving, by the receiver institution computer from the sender institution computer, the value.

These and other embodiments are described in further detail below.

### BRIEF DESCRIPTION OF THE DRAWINGS

FIG. 1 illustrates a block diagram of an interaction processing system according to an embodiment of the invention.

FIG. 2 illustrates a block diagram of a real time messaging computer according to an embodiment of the invention.

FIG. 3 illustrates a block diagram of a user device according to an embodiment of the present invention.

FIGS. 4A and 4B show a flow diagram illustrating interaction request and interaction processing.

FIGS. 5A and 5B show example screens that can be displayed by a receiver device.

FIGS. 6A and 6B show example screens that can be displayed by a sender device.

FIGS. 7A and 7B shows aspects of a multiple layer encryption and message verification scheme that can be used in embodiments for data security.

FIG. 8 shows exemplary data elements that can associated with APIs associated with the real time messaging computer when communicating with client devices such as receiver and sender institution computers.

### DETAILED DESCRIPTION

Prior to discussing embodiments of the disclosure, some terms can be described in further detail.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment.

A “receiver institution” may include any entity or group related to a receiver which is able to accept or facilitate acceptance on behalf of a receiver, such as at an account at the receiver institution.

A “sender institution” may include any entity or group related to a sender which is able to send or facilitate sending or transmission on behalf of a sender, such as at an account at the sender institution.

A “user” may include an individual. In some embodiments, a user may be associated with one or more personal accounts and/or mobile devices. The user may also be referred to as a cardholder, account holder, or consumer in some embodiments.

A “user device” may be any suitable device that a user can interact with (e.g., a payment card or mobile phone). User devices may be in any suitable form. Some examples of user devices include cards (e.g., payment cards such as credit, debit, or prepaid cards) with magnetic stripes or contactless elements (e.g., including contactless chips and antennas), cellular phones, PDAs, personal computers (PCs), tablet computers, and the like. In some embodiments, where a user device is a mobile device, the mobile device may include a display, a memory, a processor, a computer-readable medium, and any other suitable component. Examples of user devices can include receiver devices and sender devices.

A “mobile device” (sometimes referred to as a mobile communication device) may comprise any suitable electronic device that may be transported and operated by a user, which may also provide remote communication capabilities to a network. A mobile communication device may communicate using a mobile phone (wireless) network, wireless data network (e.g., 3G, 4G or similar networks), Wi-Fi, Bluetooth, Bluetooth Low Energy (BLE), Wi-Max, or any other communication medium that may provide access to a network such as the Internet or a private network. Examples of mobile devices include mobile phones (e.g., cellular phones), PDAs, tablet computers, net books, laptop computers, wearable devices (e.g., watches), vehicles such as automobiles and motorcycles, personal music players, hand-held specialized readers, etc. A mobile device may comprise any suitable hardware and software for performing such functions, and may also include multiple devices or components (e.g., when a device has remote access to a network by tethering to another device—i.e., using the other device as a modem—both devices taken together may be considered a single mobile device).

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

An “application” may be computer code or other data stored on a computer readable medium (e.g., memory element or secure element) that may be executable by a processor to complete a task.

An “authorizing entity” may be an entity that authorizes a request. Examples of an authorizing entity may be an issuer, a governmental agency, a document repository, an access administrator, etc. An “issuer” may typically refer to a business entity (e.g., a bank) that maintains an account for a user.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes and other login information, etc.

“Payment credentials” may include any suitable information associated with an account (e.g., a payment account and/or payment device associated with the account). Such information may be directly related to the account or may be derived from information related to the account. Examples of account information may include a PAN (primary account number or “account number”), username, expiration date, and verification values such as CVV, dCVV, CVV2, dCVV2, and CVC3 values.

A “token” may be a substitute value for a credential. A token may be a string of numbers, letters, or any other suitable characters. Examples of tokens include access tokens such as payment tokens, data that can be used to access secure systems or locations, etc.

A “payment token” may include an identifier for a payment account that is a substitute for an account identifier, such as a primary account number (PAN) and/or an expiration date. For example, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which sensitive data is replaced with substitute data. For example, a real credential (e.g., a primary account number (PAN)) may be tokenized by replacing the real account identifier with a substitute number that may be associated with the real credential. Further, tokenization can be applied to any other information to substitute the underlying information with a token. “Token exchange” or “de-tokenization” can be a process of restoring the data that was substituted during tokenization. For example, a token exchange may include replacing a payment token with its associated primary account number (PAN). Further, de-tokenization or token exchange may be applied to any other information to retrieve the substituted information from a token. In some embodiments, token exchange can be achieved via a transactional message, such as an ISO message, an application programming interface (API), or another type of web interface (e.g., web request).

Embodiments can enable a receiver (e.g., payee) to send a request for interaction message to a sender (e.g., payer) that did not register in advance with a real time messaging computer. The request for interaction message can be sent by the receiver to the real time messaging computer via a receiver institution computer. The request for interaction message can comprise a sender identifier (e.g., public ID) such as a phone number or email address of a sender. The real time messaging computer, upon receiving the sender identifier, can check to see if the sender identifier is stored in it (or in an alias directory). If the sender identifier is not stored in the real time messaging computer, then the real time messaging computer can transmit the sender identifier to a plurality of sender institution computers. Each sender institution computer can determine if the sender identifier is stored in it. If more than one sender institution computer has the sender identifier, then the sender can then select a sender institution computer from among the sender institution computers that have the sender identifier. The sender can then initiate the interaction using the selected sender institution computer.

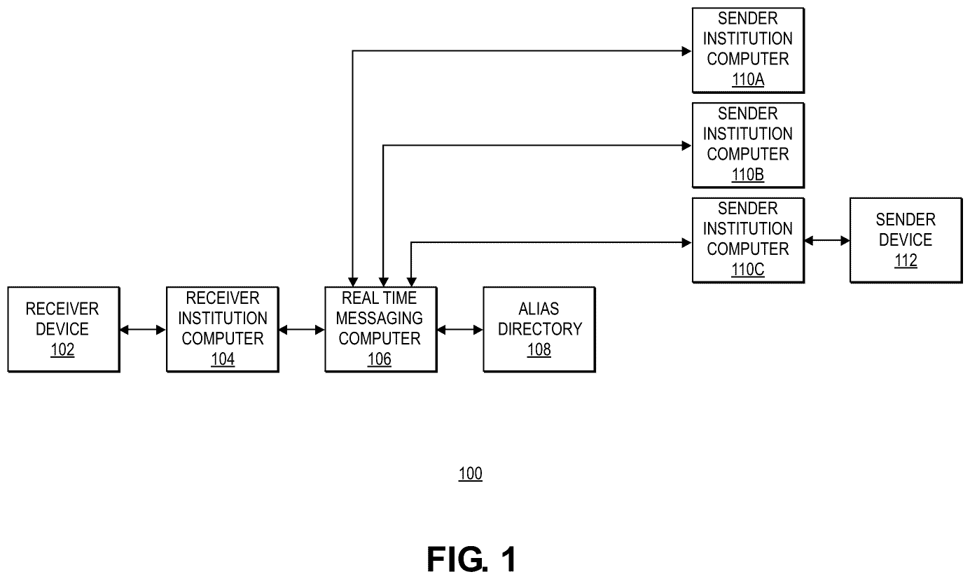

FIG. 1 illustrates an interaction processing system 100 according to an embodiment of the invention. Interaction processing system 100 can be utilized to perform interactions between receivers and senders. In some embodiments, interaction processing system 100 may be used to query or check if a sender identifier is stored in an alias directory. It is it not stored in the alias directory, then a real time messaging computer can query or check with multiple sender institution computers to determine if they store the sender identifier.

FIG. 1 shows a receiver device 102, a receiver institution computer 104, a real time messaging computer 106, an alias directory 108, sender institution computers 110A, 110B, 110C, and a sender device 112. The receiver device 102 can be in communication with the receiver institution computer 104. The sender institution computers 110A, 110B, 110C can be in communication with the real time messaging computer 106. The real time messaging computer 106 can be in communication with the alias directory 108. The receiver device 102 can be in communication with the receiver institution computer 104, which may be in communication with the real time messaging computer 106. The receiver institution computer 104 can communicate with the real time messaging computer via a first API. The sender institution computers 110A, 110B, 110C can communicate with the real time messaging computer 106 via a second API. The APIs can standardize messaging and security protocols between the real time messaging computer 106 and any external computers.

Receiver device 102 may be a mobile phone, tablet, a PDA, a laptop, or other similar device which can be used by a receiver to initiate a request to interact with a sender operating the sender device 112. In some embodiments, the receiver device 102 may contain software, such as an application to allow a receiver to transmit an interaction request message comprising an alias of the sender operating the sender device 112 to a real time messaging computer 106.

Receiver institution computer 104 may be a computing device associated with a receiver institution at which the receiver may have an account or other affiliation. For example, the receiver institution computer 104 may be associated with a financial institution with which the receiver may have an account.

The real time messaging computer 106 may be programmed to receive, process and transmit messages to and from various entities such as the receiver institution computer 104, the alias directory 108 and the sender institution computers 130A, 130B, 130C.

The real time messaging computer 106 may be associated with a payment processing network and enable functions related to a payment processing network. While a payment processing network is not illustrated in FIG. 1, it may be included in the interaction processing system 100 to enable payments, or other information, to be processed from a sender institution to a receiver institution. A payment processing network may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular includes a Visa Integrated Payments (VIP) system which processes authorization requests and a Base II system which performs clearing and settlement services. Furthermore, the payment processing network may use any suitable wired or wireless telecommunications network, including the Internet.

The alias directory 108 can be a database comprising aliases that are mapped to real credentials such as account numbers. Other information such as user information associated with the real credentials may also be stored in the alias directory.

Messages between at least the devices illustrated in FIG. 1 can be transmitted using a secure communications protocol such as, but not limited to, File Transfer Protocol (FTP); HyperText Transfer Protocol (HTTP); Secure Hypertext Transfer Protocol (HTTPS), SSL, ISO (e.g., ISO 8583) and/or the like. Although not illustrated in FIG. 1, the various components of interaction processing system 100 may be connected through or interact with one another through a telecommunications network or through short range communication. For example, a telecommunications network may include any network that is capable of transmitting information between two entities and may be capable of using any suitable communications protocol or mechanism (e.g., a cellular network, TCP/IP, Wi-Fi, radio waves, etc.). The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The sender institution computers 110A, 110B, 110C may be operated by sender institution, such as a financial institution of a sender. In some embodiments, the financial institution may be a bank.

Sender device 112 may be similar to or different than the receiver device 102.

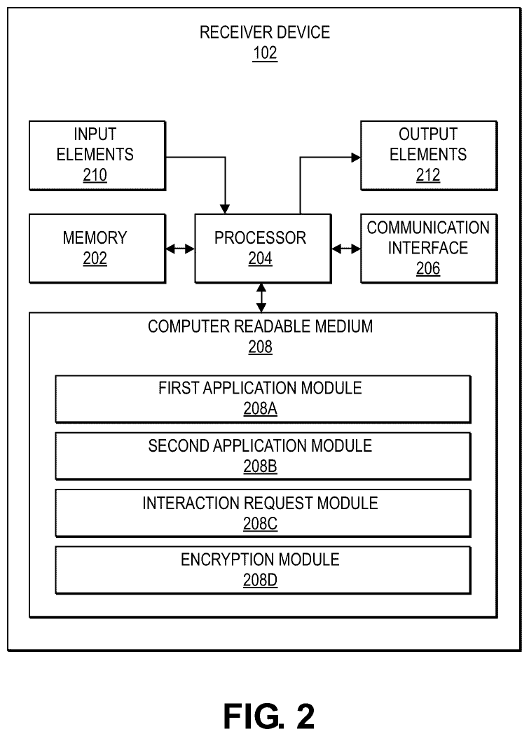

FIG. 2 shows a block diagram of the receiver device 102 according to embodiments. The exemplary the receiver device 102 may comprise a processor 204. The processor 204 may be coupled to a memory 202, a communication interface 206, input elements 210, output elements 212, and a computer readable medium 208. The receiver device may also have programs that can allow it to initiate a request to interact process from an intended sender, and display the outcome of the request to interact process on the receiver device.

The memory 202 can be used to store data and code. The memory 202 may be coupled to the processor 204 internally or externally (e.g., cloud based data storage), and may comprise any combination of volatile and/or non-volatile memory, such as RAM, DRAM, ROM, flash, or any other suitable memory device. For example, the memory 202 can store interaction data, application data, etc.

The one or more input elements 210 may include any suitable device(s) capable of inputting data into the receiver device 102. Examples of input elements 210 include buttons, touchscreens, touch pads, microphones, cameras, etc.

The one or more output elements 212 may comprise any suitable device(s) that may output data. Examples of output elements 212 may include display screens, speakers, and data transmission devices.

The computer readable medium 208 may comprise several software applications and/or software modules. Examples of such modules can include a first application module 208A, a second application module 208B, an interaction request module 208C, and an encryption module 208D. The first application module 208A and the second application module 208B can contain different applications which allow a receiver to request value (e.g., money) from a sender. The first and second application modules 208A, 208B can be different authorizing entity applications (e.g., issuer applications) or digital wallet applications. The authorizing entity applications may be associated with sender or receiver financial institutions. The interaction processing module 208C in conjunction with the processor 204 can cause the receiver device 102 to generate and transmit an interaction request message associated with an interaction, and to receive messages associated with the interaction. The interaction request message may comprise at least an amount and a sender identifier. The encryption module 208D can comprise code which causes the processor 204 to perform encryption or decryption functions, and signature and verification functions. Cryptographic keys for the encryption and decryption can be stored in the memory 202.

The communication interface 206 may include one or more devices and software that can allow the receiver device 102 to communicate with external computers or devices. The communication interface 206 may enable the receiver device 102 to communicate data to and from another device (e.g., a resource provider device, a resource provider server, a portable device, a device, computer, and/or server of a processing system, etc.). Some examples of the communication interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the communication interface 206 may include Wi-Fi™. Data transferred via the communication interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the communication interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium. The communication interface 206 may be associated with or operated in conjunction with a communication API.

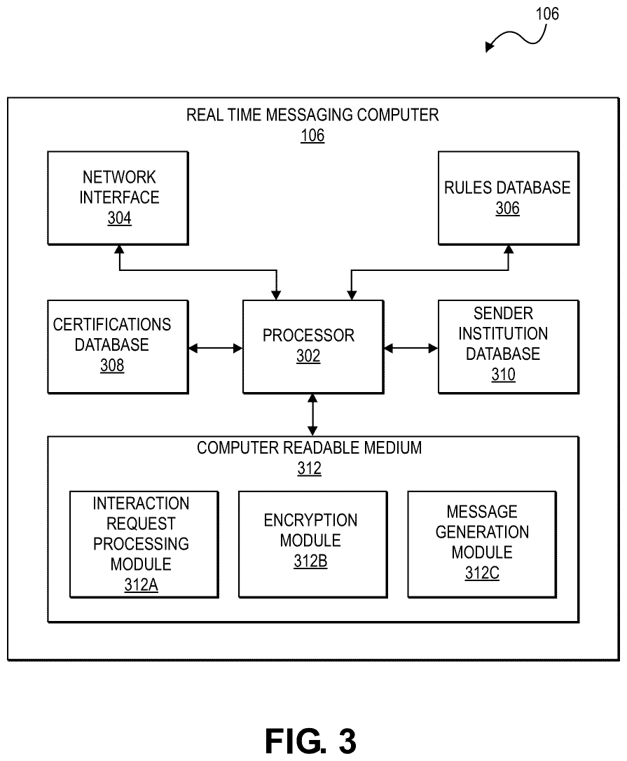

FIG. 3 illustrate components of the real time messaging computer 106. The real time messaging computer 106 may include a processor 302 coupled to a network interface 304, a rules database 306, a certifications database 308, a sender institution database 310, and a computer readable medium 312.

The computer readable medium 312 may comprise code executable by the processor 302 for implementing methods using embodiments of the invention. For example the code may be executable by the processor 302 to perform a method comprising: receiving, from a receiver institution computer, an interaction request message for an interaction comprising a sender identifier associated with a sender and interaction details; transmitting a plurality of notifications comprising the sender identifier to a plurality of sender institution computers; receiving a plurality of responses from the plurality of sender institution computers, one or more responses indicating that the sender identifier is stored at the sender institution computers; and providing the interaction details and/or additional interaction details to one or more of the sender institution computers that store the sender identifier.

The computer readable medium 312 may include an interaction request processing module 312A, an encryption module 312B, and a message generation module 312C. The interaction request processing module 312A, in conjuction with the processor 302, may process interaction request messages. Encryption module 312B may contain code and algorithms to enable decryption, encryption, signing, and signature verification. Message generation module 312C, in conjunction with the processor 302, may enable the generation of messages to facilite an interaction.

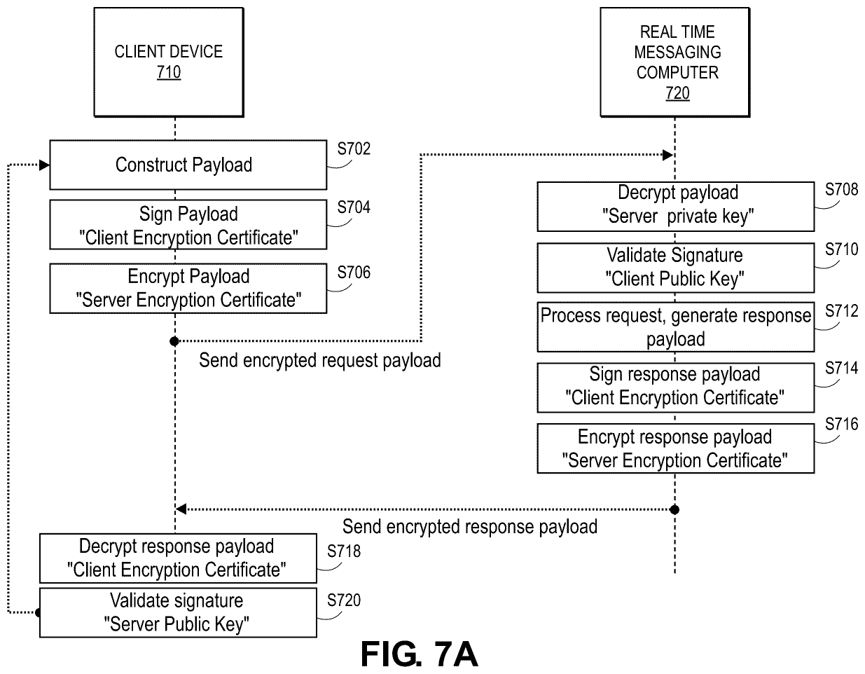

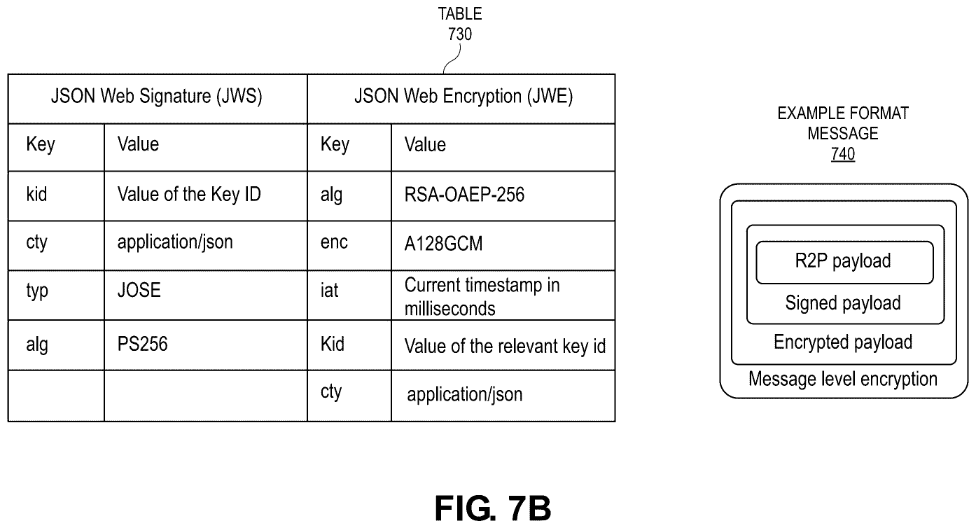

Certifications database 308 may contain one or more digital certificates or other digitally signed identifiers or documents which can verify the identify of the real time messaging computer 106. Certifications database 308 may also contain private and public keys to enable secure communication with other entities in interaction processing system 100. Example uses of the certificates are described below with respect to FIGS. 7A and 7B.

Sender institution database 310 may contain a list of identifiers or network addresses to identify sender institution computers and request information from or send messages to them.

Rules database 306 may store rules to facilitate interaction processing. For example, if a interaction request message that is sent to the alias directory 108 indicates that an alias is known or found for a particular sender alias, the rules database can ensure that the real time messaging computer 106 does not further instantiate messages to the sender institution computers 110A, 110B, 110C.

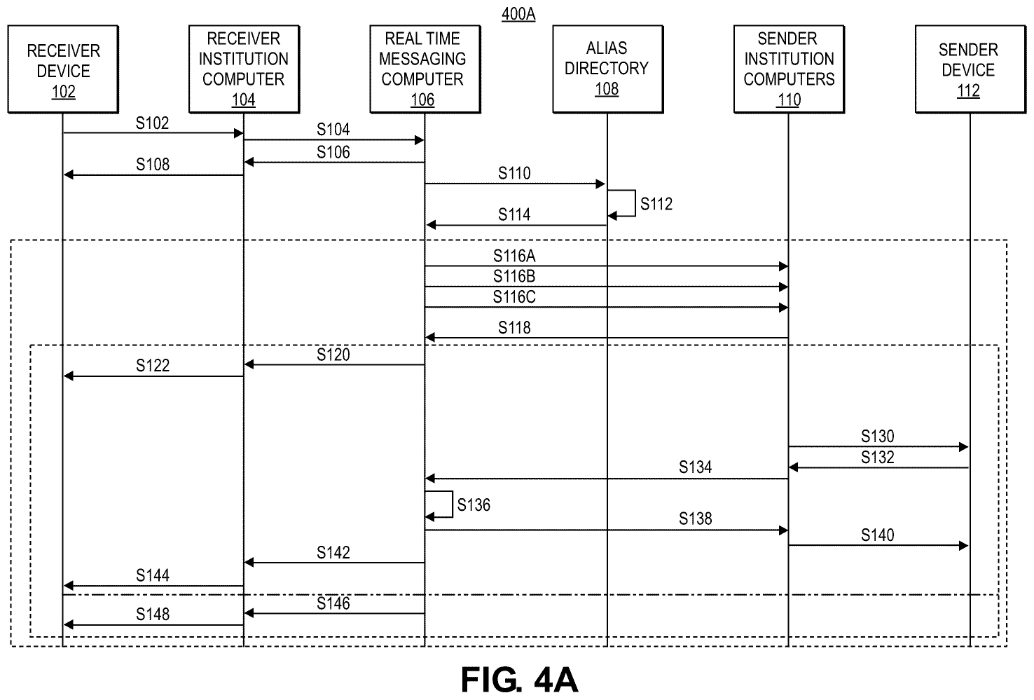

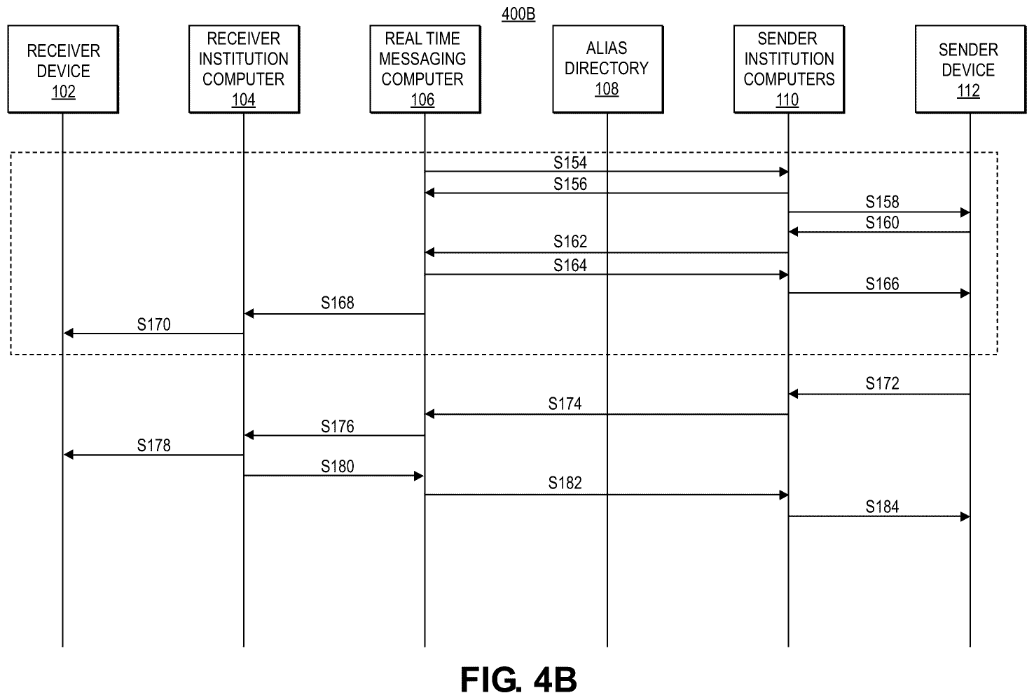

FIGS. 4A and 4B show a flow diagram of illustrating steps in an interaction (e.g., a transaction) according to embodiments. A receiver can use the receiver device 102 to send an interaction request message comprising a sender identifier (e.g., alias) to a receiver institution computer 104. The receiver institution computer 104 can send the interaction request message to a real time messaging computer 106. The real time messaging computer 106 can use an alias directory 108 to determine if the sender identifier is stored in the alias directory 108. The alias directory 108 can store all the aliases enrolled by the real time messaging computer 106. The aliases are mapped to real credentials and also sender or receiver institutions associated with the credentials. If the alias is not stored in the alias directory 108, the real time messaging computer 106 can send the interaction request message to the sender institution computers 110A, 110B, 110C. Each sender institution computer 110A, 110B, 110C can determine if they have the alias, and if they do, then they can notify the real time messaging computer 106. The sender can select a sender institution computer to initiate the interaction (e.g., a payment transaction) with the sender operating the sender device 112.

Steps S116 to S148 can comprise steps when the sender identifier is not an alias stored in the alias directory 108. Steps S120 to S144 can comprise steps when there is at least one sender institution computer that sends a successful response of an account corresponding to the sender identifier. Steps S146 and S148 can comprise steps when there is no sender institution computer that sends a successful response of an account corresponding to the sender identifier. Steps S154 to S170 can comprise steps when the sender identifier is an alias stored in the alias directory 108. Steps S172 to S184 can comprise steps for an original credit transaction (OCT) transaction. An OCT (Original Credit Transaction) is typically a clearing and settlement credit transaction designed for use in business applications such as a business money transfer or business-to-consumer repayments. In embodiments of the invention, the OCT can be used to deliver funds to the receiver account. This timing can ensure that payment funds are secured before funds are sent to the receiver. The amount of the OCT can be the amount agreed to by the sender and the service provider in the currency agreed. The OCT can carry the account number of the receiver and no information about the sender. A special indicator can identify an OCT to the receiver's issuer bank. Settlement can take place within two days, or more or less time than this. Details of OCT transactions can be found in U.S. Pat. No. 8,851,366 which is incorporated by reference in its entirety.

In step S102, the receiver can use the receiver device 102 to send an interaction request message comprising a sender identifier and payment details (an example of interaction details) to the receiver institution computer 104 using the receiver institution's application or a browser page. The sender identifier and the payment details can be provided by the receiver operating the receiver device 102. The sender identifier can be a public identifier such as a phone number or an email address. The payment details can include a request amount, a due date, a request note, etc. Other payment details such as a receiver name, a receiver alias, a receiver credential, etc. can be provided by the receiver financial institution's application or the browser page.

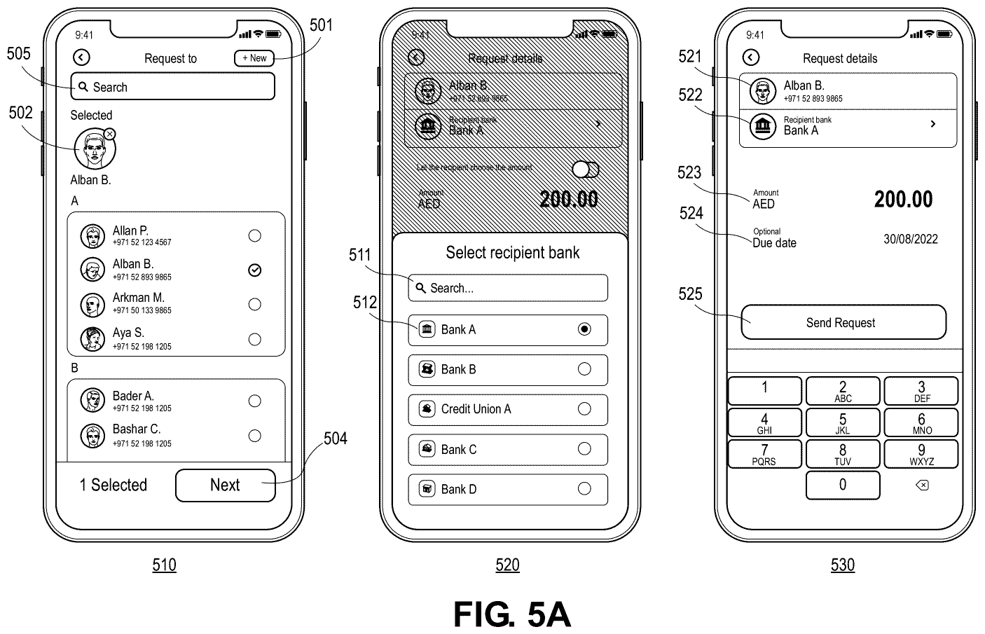

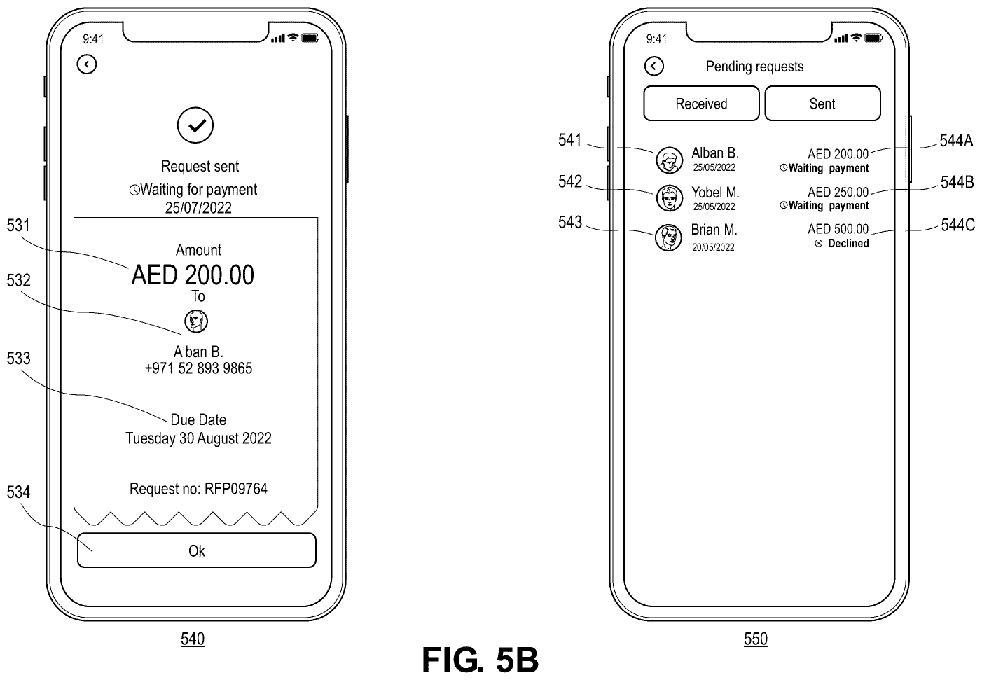

In some embodiments, the sender identifier may be saved in a contacts application on the receiver device 102 from a previous real time payment transaction, and the receiver may simply click the sender's contact information to send the interaction request message to the sender. The receiver device 102A can show a list of receiver financial institutions. The receiver can select one which they can use to receive transferred funds. The receiver can then enter payment details and send the interaction request message to the receiver institution computer 104. This is shown in screens 510, 520, and 530 in FIG. 5A.

In step S104, the receiver institution computer 104 can send the interaction request message comprising the sender identifier (e.g., alias) and the payment details to the real time messaging computer 106. In step S106, the real time messaging computer 106 can send a notification to the receiver institution computer 104 that the interaction request message is received by the real time messaging computer 106. In step S108, the receiver institution computer 104 can notify the receiver device 102 that the interaction request message has been sent. This step can correspond to screen 540 of FIG. 5B. In some embodiments, steps S106 and S108 can occur after step S114.

In some embodiments, the real time messaging computer can determine a fraud score based on a fraud analysis using data in the interaction request message. It can decline the interaction request if the fraud score exceeds a threshold. For example, if the amount in the interaction request message is very high and if the interaction request message originates from a receiver device with a suspicious IP address, then the interaction request message may be indicative of fraud. A fraud score can be generated and the fraud score can exceed an acceptable threshold.

In step S110, the real time messaging computer 106 can send the sender identifier to the alias directory 108. In step S112, the alias directory 108 can determine if the sender identifier is stored in the alias directory 108. The alias directory 108 can perform a database lookup to determine if the alias directory 108 stores the sender identifier. In step S114, the alias directory 108 can notify the real time messaging computer 106 as to whether the sender identifier is stored in the alias directory 108.

If the sender identifier is not stored in the alias directory 108, the steps S116 to S148 can be performed and steps S154 to S170 can be omitted. Otherwise, the steps S116 to S148 can be omitted and the steps S154 to S170 can be performed.

In step S116, if the sender identifier is not stored in the alias directory 108, the real time messaging computer 106 can transmit a plurality of notifications, each comprising the sender identifier, to a plurality of sender institution computers. For example, the real time messaging computer 106, in step S116A, can send a notification to one sender institution computer. In step S116B, the real time messaging computer 106 can send a notification to another sender institution computer. In step S116C, the real time messaging computer 106 can send a notification to yet another sender institution computer.

In some embodiments, the real time messaging computer 106 can prioritize a particular sender financial institution to send the notification of the interaction request message. For example, the real time messaging computer 106 can select the sender financial institution with historically fastest response indicating that it stores the sender identifier as the first sender financial institution to send the notification to the sender institution computer.

In step S118, the real time messaging computer 106 can receive a plurality of responses from the plurality of sender institution computers. If one or more responses from the plurality of responses indicates that the sender identifier is stored at the sender institution computers, then steps S120 to S144 can occur and the steps S146 and S148 can be omitted. Otherwise, steps S120 to S144 can be omitted and the steps S146 and S148 can occur.

In step S120, if one or more responses from the plurality of responses indicates that the sender identifier is stored at the sender institution computers 110, the real time messaging computer 106 can send a status change notification (e.g., “Request delivered”) to the receiver institution computer 104 that the interaction request message has been delivered to the sender's financial institution. In step S122, the receiver institution computer 104 can send the status change notification (e.g., “Message delivered”) to the receiver device 102. The status change can be reflected on the status of the pending request 544 of screen 550 in FIG. 5B.

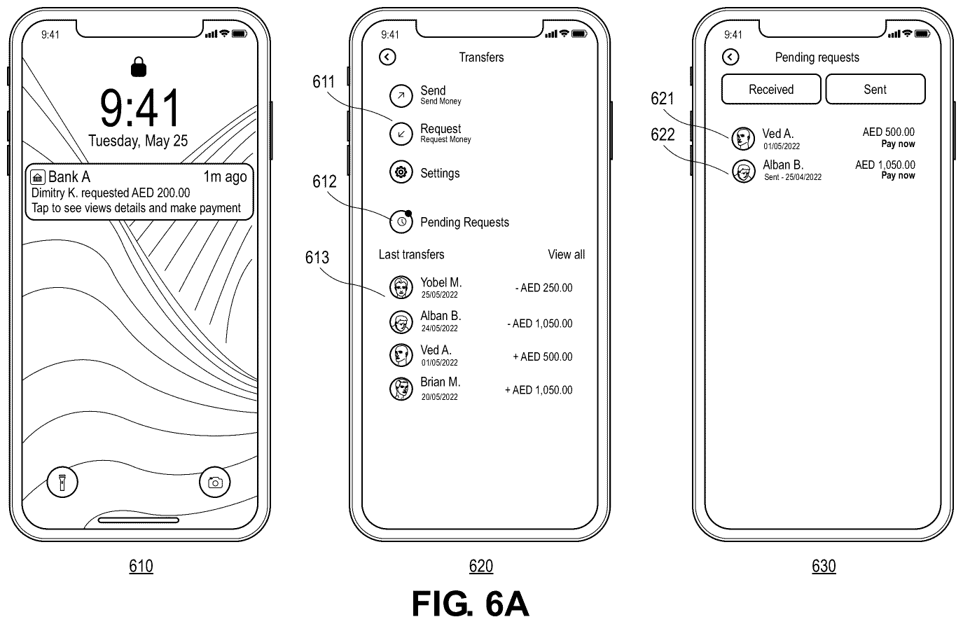

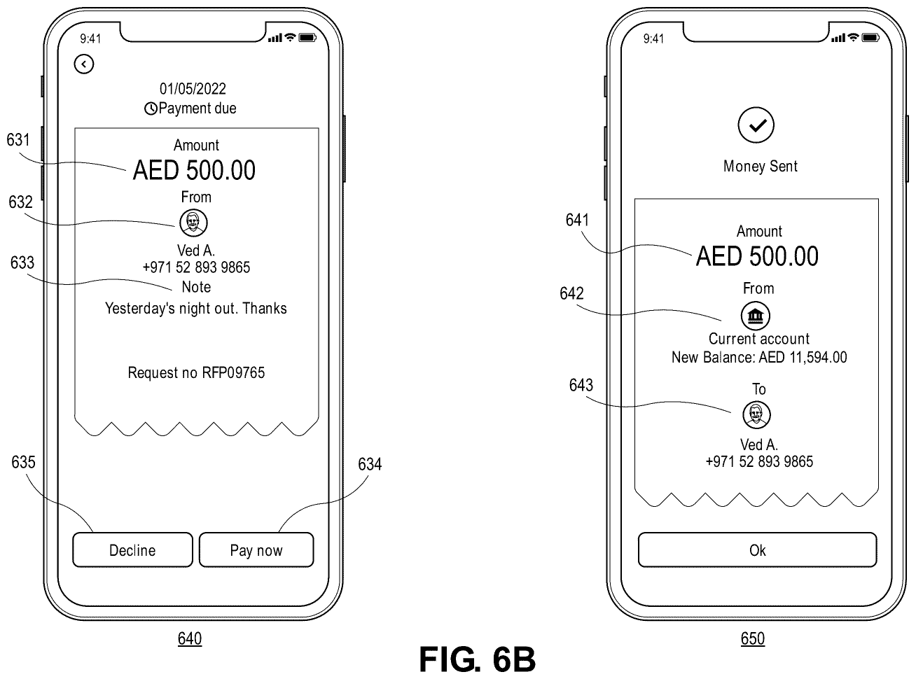

In step S130, the sender institution(s) computer can send the notification to the sender device 112 associated with the sender. In step S132, the sender can use the sender device 112 to open the notification and select to view details of the interaction request message to the sender institution computers 110. This can correspond to screen 610 of FIG. 6A. The sender can then respond to the notification to indicate that the request to pay is approved. The notification and the response may be sent via an application such as a sender institution application or a digital wallet in some embodiments of the invention. In some cases, if multiple sender institution computers have the sender's alias, then the sender device 112 can receive multiple notifications.

In step S134, the selected sender institution computer can send a request to fetch payment details to the real time messaging computer 106. In step S136, upon receiving the request to fetch the payment details, the real time messaging computer 106 can map the sender financial institution that sent the request to fetch, as the default sender financial institution for the sender's alias. The real time messaging computer 106 can also map sender's alias to other sender institutions that sent responses indicating that the sender identifier is stored in their computers. In some embodiments, the receiver's credentials (e.g., an account number of the receiver) may be stored in alias directory 108. The receiver's credentials may be retrieved using a receiver alias that is present in an interaction request message. In this case, the receiver's credentials may be considered to be additional interaction details.

In step S138, the real time messaging computer 106 can send the payment details to the sender institution computer 110. The payment details or additional details may include, for example, the receiver's credential (e.g., a PAN and optionally a CVV2 and expiration date). In step S140, the selected sender institution computer can send any further interaction or payment request details to the sender device 112. In some cases, the interaction request details that are sent to the sender device 112 may include all interaction request details from the original interaction request generated by the receiver financial institution.

In step S142, the real time messaging computer can send a status change notification (e.g., “Request viewed”) to the receiver institution computer 104 that the interaction request message has been viewed by the sender using the sender device 112. In step S144, the real time messaging computer can send the status change notification (e.g., “Message viewed”) to the sender. The status change can be reflected on the status of the pending request 544 of screen 550 in FIG. 5B.

In step S146, if none of the responses from the plurality of responses indicates that the sender identifier is stored at the sender institution computers, the real time messaging computer 106 can send a status change notification (e.g., “Request un-delivered”) that the interaction request message has not been delivered to the sender using the sender device 112 as there was no sender institution computer with a response indicating that they have the sender identifier. In step S148, the status change notification (e.g., “Payer not found”) can be sent to the receiver device 102. The status change can be reflected on the status of the pending request 544 of screen 550 in FIG. 5B.

In step S154, if the sender identifier is an alias stored in the alias directory 108, the real time messaging computer 106 can transmit a notification of the interaction request message comprising the sender identifier to the sender institution computer(s) 110 that is/are mapped to the sender identifier. In step S156, the sender institution computer can send a response indicating that the sender identifier is stored at one or more of the sender institution computers 110.

In step S158, the sender institution computer(s) 110 can send the notification of the interaction request message to the sender device 112. In step S160, the sender can use the sender device 112 to open the notification and select to view payment details of the interaction request message. This can correspond to screen 610 of FIG. 6A. In step S162, the sender institution computers 110 can send a request to fetch payment details to the real time messaging computer 106.

Steps S164 to S170 can be similar to steps S138 to S144, and therefore will not be repeated herein.

In step S172, the sender can confirm the payment after viewing the payment details and can initiate a real time interaction (e.g., a real time payment transaction) with a selected sender institution computer using the sender device 112. This can correspond to screens 620, 630, and 640 of FIGS. 6A and 6B.

In step S174, the selected sender institution computer can transfer (i.e., push) funds from the sender's financial account in the sender institution computers 110 to the real time messaging computer 106. The selected institution computer can generate a message such as an OCT message comprising at least the amount of the interaction and a credential or token associated with the receiver's account at the receiver institution computer 104. In step S176, the real time messaging computer 106 can transfer the funds to the receiver institution computer 104. In step S178, the receiver institution computer 104 can then send a notification that the funds have been credited to the receiver's account through the receiver device 102. The OCT funds transfer process described above can be used in steps S174-S178.

In step S180, the receiver institution computer 104 can transmit a settlement ID for the payment received to the real time messaging computer 106. In step S182, the real time messaging computer 106 can send the settlement ID to the selected sender institution computer. In step S184, the selected sender institution computer can send a notification to the sender device 112 that the funds have been debited. This can correspond to screen 650 of FIG. 6B.

FIGS. 5A and 5B show example screens of a receiver (e.g., payee) device during the process of requesting an interaction (e.g., a payment transaction) with a sender. The receiver device may be in operative communication with a receiver financial institution. Screen 510 shows a contacts page, screen 520 can show receiver banks that can be selected by a receiver to receive money, screen 530 can be a page that requests details regarding a transaction, screen 540 can be a page showing that an interaction request message has been sent, and screen 550 can show the statuses of various interaction request messages for different potential senders.

The receiver device can display the screen 510. The screen 510 can be launched when the receiver decides to request an interaction with a sender. The screen 510 have a list of senders from which the receiver can receive funds. In the screen 510, the receiver selects a sender with a name “Alban B”. Upon selecting the sender, the receiver can select a next button 504.

The receiver device can display the screen 520. The screen 520 can be launched after the user clicks the next button 504 in the screen 510. The screen 520 allows the receiver to choose a receiver's financial institution (e.g., bank) from in which the receiver wants to receive funds.

The receiver device can display the screen 530 that requests details of the proposed interaction (e.g., proposed payment transaction). The receiver can enter a requested amount in an amount box 523, enter due date in date box 524, and check whether the selections of the sender 521 and the financial institution 522 are correct. Upon checking the information, the receiver can click send request button 525 to send an interaction request message from the receiver financial institution to the real time messaging computer.

The receiver device can display the screen 540 showing that a request has been sent. The screen 540 can have a summary of the payment details and sender identifier 532 for the requested interaction. The payment details can include payment amount 531 and payment due date 533. Upon reviewing the summary of the requested interaction, the receiver can click ok button 534 to continue.

The receiver device can display the screen 550 showing the states of the various interaction request messages. The pending screen 550 can have a list of senders to which the receiver has sent interaction request messages. For example, the most recent interaction request message can be shown in as a pending request 541. Request 542 is also pending, and request 543 was declined. Each request can identify the sender's name, the amount requested for the interaction, date by which the requested amount is to be delivered, and statuses of the requests 544A, 544B, 544C.

FIGS. 6A and 6B show example screens shown on a sender device (e.g., a payer device) during an interaction request process. The sender device may be in operative communication with a sender institution computer to send a payment responding to an interaction request message. A screen 610 can be a notification page, a screen 620 can be a transfer page, a screen 630 can be a pending page, a screen 640 can be a pay now page, and a screen 650 can be a money sent page.

The sender device can display the screen 610, which can be notification page. The notification page can contain an interaction request message notification 601 from the receiver. The notification 601 can comprise the receiver's name, amount requested, etc.

The sender device can display the screen 620. The transfer page can be launched upon the sender clicking on the notification. The transfer page can display a history of real time payment transfers 613, a pending request option 612, and transfer options 611 including send payment, request payment, and settings.

The sender device can display the screen 630 showing details of interaction request messages. The screen 630 can show the pending interaction request messages received by the sender device. Two requests to pay 621, 622 are shown. In a request, the name, the amount requested, the date requested, and the date of request can be shown. The sender can select a request associated with a receiver if it wants to send the funds to the receiver.

The sender device can display a pay now screen 640. The pay now screen 640 can be launched after the sender clicks on one of the pending requests from the screen 630. The pay now screen 640 can comprise the payment details about the interaction request message. The payment details can include the transaction amount 631, the receiver's name 632, and a payment note 633. The sender can select a pay now button 634 or decline button 635 after reviewing the payment details.

The screen 650 shows that money has been sent. The screen 650 can be launched after the sender clicks the pay now button 634. The screen 650 can comprise the summary of the completed payment. The summary can comprise the request amount the sender sent 641, the bank account the sender sent the request amount with 642, and the receiver 643.

FIGS. 7A and 7B illustrate aspects related to encryption between a client device 710 and a real time messaging computer 720. The client device 710 may be the receiver institution computer or a sender institution computer. FIG. 7A shows a process using a two-way transport layer secure, message level security and signing. The process can be used to provide security for messages received by the real time messaging computer 720 and transmitted by the real-time messaging computer.

In step S702, the client device 710 may construct a request payload (e.g., an interaction request message).

In step S704, the client device 710 can sign the request payload using a private key associated with a client encryption certificate.

In step S706, the client device can encrypt the request payload using a public key of a server encryption certificate. The client device can then send the encrypted payload to the real time messaging computer 720.

In step S708, the real time messaging computer 720 can decrypt the encrypted payload using a private key associated with the server encryption certificate.

In step S710, the real time messaging computer 720 can verify or validate the signature of the message using a public key associated with the client encryption certificate.

In step S712, the real time messaging computer 720 can process the payload. For example, a notification message informing the client device 710 that an interaction request message has been accepted may be generated or received by the real time messaging computer 720. This may be a response payload.

In step S714, the real time messaging computer 720 can sign the response payload with a private key associated with the server encryption certificate.

In step S716, the real time messaging computer 720 can encrypt the response payload with the public key associated with the client encryption certificate. The encrypted and signed response payload can be sent to the client device 710.

In step S718, the client device 710 can decrypt the response payload using a private key associated with the client encryption certificate.

In step S712, the client device 710 can verify or validate the signature of the response payload using the public key associated with the server encryption certificate.

FIG. 7B illustrates table 730 and message 740. The table 730 illustrates example values for various JSON web signatures and JSON web encryption aspects which can be used to encode and encapsulate messages. The JSON Web Signatures can include various fields such as those illustrated in table 730. Similarly, the JSON Web Encryption may include various keys and corresponding values. The values and keys illustrated in table 730 are exemplary and other keys and key values may be included. Message 740 may contain various levels or layers to a message, and may be formed with the process described above with respect to FIG. 7A. Included in message 740 is a payload, which is signed, encrypted, and further encrypted.

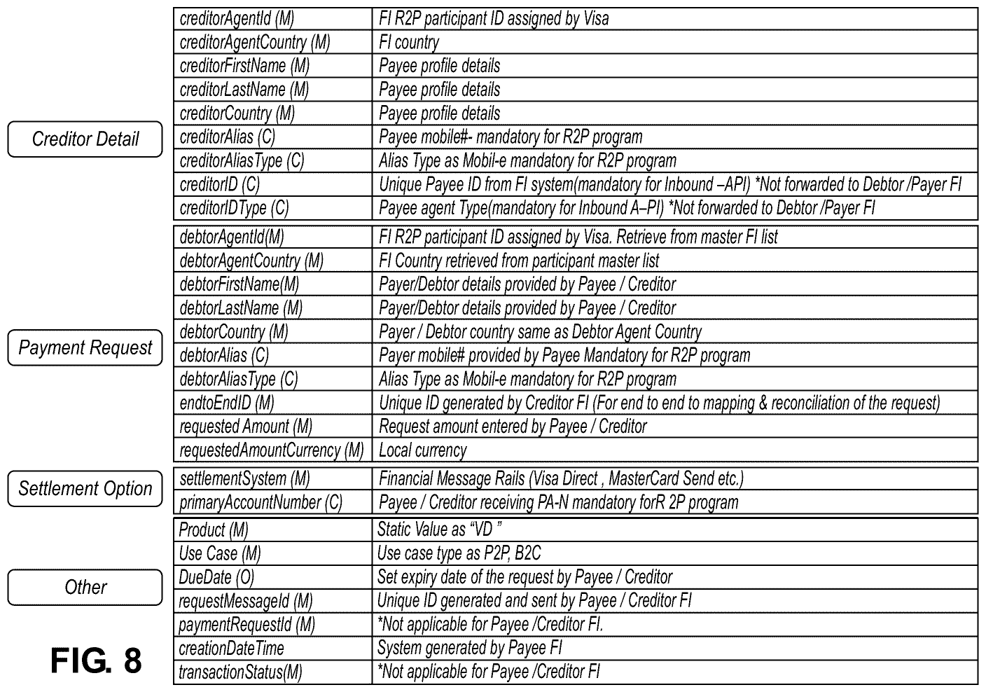

FIG. 8 shows exemplary data elements that can associated with APIs associated with the real time messaging computer when communicating with client devices such as receiver and sender institution computers. As shown, the various data elements can include data which can be included in the above-described interaction request messages.

Embodiments of the invention have a number of technical advantages. Embodiments of the invention can allow a user to receiver to request an interaction such as a payment transaction from a sender of funds using an alias of the sender, even though that the alias and its corresponding credential are not registered with an alias directory. While conventional systems would simply decline requested interactions if the alias could not be found in the alias directory, embodiments of the invention provide for an efficient way to remedy this problem by communicating with various sender institution computers in real time. The outcome of doing so is that the sender can conduct an interaction (e.g., make a payment) to the receiver, even though the sender did not register their alias with the alias directory. This can prevent the receiver from having to submit multiple interaction request messages through other means to complete an interaction. Further, registration of aliases is not required to perform alias interactions. Thus, embodiments of the invention save on computing resources since additional processing associated with resubmitting interaction requests and enrollment messages is not necessary in embodiments of the invention.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a real time messaging computer from a receiver institution computer, an interaction request message for an interaction comprising a sender identifier associated with a sender and interaction details;
transmitting, by the real time messaging computer, a plurality of notifications comprising the sender identifier to a plurality of sender institution computers;
receiving, by the real time messaging computer, a plurality of responses from the plurality of sender institution computers, one or more responses indicating that the sender identifier is stored at the sender institution computers; and
providing, by the real time messaging computer, the interaction details and/or additional interaction details to one or more of the sender institution computers that store the sender identifier.

2. The method of claim 1, wherein the sender institution computer initiates a real time transaction by transferring funds from one of the one or more sender institution computers to the receiver institution computer after the real time messaging computer provides the interaction details and/or additional interaction details to the one sender institution computer.

3. The method of claim 2, wherein the real time transaction is an OCT transaction.

4. The method of claim 1, wherein the receiver institution computer communicates with the real time messaging computer via a first API and the plurality of sender institution computers communicate with the real time messaging computer via a second API.

5. The method of claim 1, wherein the sender identifier is an alias.

6. The method of claim 1, further comprising:
determining, by the real time messaging computer, a fraud score based on a fraud analysis using data in the interaction request message, and declining by the real time messaging computer if the fraud score exceeds a threshold.

7. The method of claim 1, wherein the sender identifier is an alias, and wherein the real time messaging computer communicates with an alias directory and determines that the alias is not stored in the alias directory.

8. The method of claim 1, wherein the interaction details comprise an amount.

9. The method of claim 1, wherein the interaction request message is signed using a private key associated with the receiver institution computer.

10. The method of claim 9, wherein the interaction request message is encrypted using a public key of the real time messaging computer.

11. The method of claim 1, wherein the one or more responses is two or more responses.

12. The method of claim 1, wherein one of the one or more sender institution computers initiates a real time transaction by transferring funds from the sender institution computer to the receiver institution computer after the real time messaging computer provides the interaction details and/or additional interaction details to the sender institution computer, wherein the interaction details and/or additional interaction details comprise a credential or a token associated with a receiver associated with a receiver institution operating the receiver institution computer.

13. The method of claim 12, wherein the additional interaction details comprise the credential, the credential being an account identifier of the receiver.

14. The method of claim 1, wherein one of the one or more sender institution computers initiates a real time transaction by transferring funds from the sender institution computer to the receiver institution computer after the real time messaging computer provides the interaction details to the sender institution computer, wherein the interaction details comprise a credential or a token associated with a receiver associated with a receiver institution associated with the receiver institution computer, wherein the receiver institution computer transmits a notification message to a receiver device of a receiver indicating that the interaction has completed.

15. A real time messaging computer comprising:
a processor; and
a non-transitory computer readable medium comprising code, executable by the processor, to perform a method comprising:
receiving, from a receiver institution computer, an interaction request message for an interaction comprising a sender identifier associated with a sender and interaction details;
transmitting a plurality of notifications comprising the sender identifier to a plurality of sender institution computers;
receiving a plurality of responses from the plurality of sender institution computers, one or more responses indicating that the sender identifier is stored at the sender institution computers; and
providing the interaction details and/or additional interaction details to one or more of the sender institution computers that store the sender identifier.

16. A method comprising
receiving, by a receiver institution computer, an interaction request message associated with an interaction, the interaction request message comprising a sender identifier associated with a sender and interaction details comprising a value from a receiver device;
transmitting, by the receiver institution computer, the interaction request message to a real time messaging computer, wherein the real time messaging computer transmits a plurality of notifications comprising the sender identifier to a plurality of sender institution computers, and receives a plurality of responses from the plurality of sender institution computers, indicating that the sender identifier is stored at the sender institution computers; and
receiving, by the receiver institution computer from the sender institution computer, the value.

17. The method of claim 16, wherein the sender identifier is an alias.

18. The method of claim 17, wherein the real time messaging computer determines if the alias is not an alias directory that stores aliases and corresponding credentials.

19. The method of claim 17, wherein the alias is a username, phone number, or e-mail address.

20. The method of claim 17, further comprising:
transmitting, by the receiver institution computer, a notification message to the receiver device.
